(19) United States
(12) Patent Application Publication
(10) Pub. No.: US 2016/0149382 A1
(43) Pub. Date: May 26, 2016

(54) A BENDABLE FLAT CABLE

(71) Applicant: Niv BEN-ARIS,, New York, NY (US)

(72) Inventor: Michael ZETTNER, Gan Yavne (IL)

(21) Appl. No.: 14/903,469

(22) PCT Filed: Jul. 1, 2014
(86) PCT No.: PCT/IL2014/050592

§ 371 Date: Jan. 7, 2016

(30) Foreign Application Priority Data
Jul. 11, 2013 (IL) 227451

(51) Int. Cl. H02G 1/06

(52) U.S. Cl. CPC H02G 1/06

(57) ABSTRACT

The invention is a flat cable comprised of stable flat plates connected together to form a long chain. The plates are made from a rigid material and have channels for electric conductors on their undersides. The channels are created as recesses in the bottom of the plates such that they do not run parallel to the side edges of the long chain of plates but at angles to the side edge in a zigzag or wave-like pattern.

### FIELD OF THE INVENTION

The present invention is from the field of cable systems that are used to transfer, for example: information, signals, music, and low-voltage direct-current electricity. Specifically the invention is from the field of flat cable systems.

### BACKGROUND OF THE INVENTION

In many cases cables provide a connection between two devices that are not always at or on the same workspace or table. For example a shared printer and a computer of an individual worker typically do not stand at or on the same table, and frequently are not even close to each other. In such cases the connecting cables have to bridge the distance between two places or points. Usually these cables are attached to walls or to floors in such a way that they will not be loose and create a safety hazard. In many countries regulations require that cables be fixed to walls and forbid that cables cross floors where people might walk and stumble over them.

It is not always possible to mount and fix cables alongside walls or other solid structures, e.g. in the case of a conference table with devices on it that stands alone in the center of a meeting-room. A typical solution in such cases is to create channel-like openings in the floor that allows the cable or cables to be laid below the floor level. This is costly and in many cases difficult because it creates disturbances of all kinds when floors have to be opened.

Flat cables are cables comprised of several parallel conductors separated by insulating material and arranged in a single plane. A typical flat cable is described in European patent application EP1727161. In common with other known flat cables, the flat cable described in this patent application has no protection against breakage of the conductors when stepped upon or if side forces are exerted on it.

It is a purpose of the present invention to provide a very flat cable system that can be fixed along walls, under furniture, and under a carpet or a wall-to-wall carpet without visibly increasing the height of the carpet.

It is another purpose of the present invention to provide a very flat cable system that comprises protection against stepping on it or rolling carts over it and is flat enough not to present a safety hazard to persons walking over it.

It is another purpose of the present invention to provide a very flat cable system that is inexpensive and simple to install.

Further purposes and advantages of this invention will appear as the description proceeds.

### SUMMARY OF THE INVENTION

The invention is a flat cable comprised of stable flat plates connected together to form a long chain. The plates are made from a rigid material and have channels for electric conductors on their undersides. The channels are created as recesses in the bottom of the plates such that they do not run parallel to the side edges of the long chain of plates but at angles to the side edge in a zigzag or wave-like pattern.

In embodiments of the flat cable of the invention the height of the plates is between 0.5 mm to 0.6 mm.

Embodiments of the flat cable of the invention comprise eight channels for eight signal wires or six signal wires and two low voltage DC wires.

In embodiments of the flat cable of the invention the plates have dimensions of 70 mm×60 mm×0.55 mm (length×width×height).

In embodiments of the flat cable of the invention at least one of the sides that form one of the two edges parallel to a longitudinal axis of the chain of plates comprises an overhanging edge that creates a space beneath it. In these embodiments, double-sided glue tape can be inserted into the spaces in order to do at least one of the following: to fix the flat cable to a floor; to attach the cable to a rug or carpet that is laid over it by means of a part of the double-sides glue tape that is not covered by the overhanging edge; to connect flat cables in parallel to each other by fixing two adjacent flat cables on the same glue tape.

In embodiments of the flat cable of the invention at least some of the plates comprise at least one hole that passes vertically through them. In these embodiments the holes can be used to allow fixing elements to attach the plate to an object.

In embodiments of the flat cable of the invention the plates are connected together by the insulated wires, which fit tightly into the wire channels; thereby maintaining adjacent plates butted up against one another or with a small gap between them.

In embodiments of the flat cable of the invention adjacent plates are connected to each other by means of an interlocking mechanism. In these embodiments the interlocking mechanism can comprise at least one of: interlocking pairs of U-shaped hooks; projections on one edge of a plate that fit into mating recesses on the edge of an adjacent plate; an electrical bridge.

In embodiments of the flat cable of the invention the cable is electrically grounded. In these embodiments electrical grounding can be accomplished in at least one of the following ways: using a conducting material to manufacture the plates and butting them firmly against one another; during production leaving at least one small link of metal between two scales at their seam-line that can function as an electrical bridge; attaching a continuous conductor to each plate in the chain during the manufacturing process; to use an interlock mechanism to provide electrical continuity between adjacent plates.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 is a top view schematically showing a number of scales connected together in the basic embodiment of the flat cable of the invention and a vertical cross section through the end scale;

FIG. 2a to FIG. 2c schematically show how side forces resulting from a person stepping on a scale would cause it to bend if the channels were straight;

FIG. 3 schematically shows the bottom side of the flat cable of FIG. 1 revealing the zigzag-pattern of the channels for the electrical conductors;

FIG. 4 schematically shows a force exerted perpendicular to the side of a scale of the invention and smaller arrows, representing the force-vectors of components of this force;

FIG. 5 schematically shows a flat cable of the invention with two double-sided glue tapes attached;

FIG. 6 schematically shows how two flat cables of the invention can be connected in parallel to each other;

FIG. 7a and FIG. 7b schematically show an embodiment of a way in which adjacent scales can be connected to each other by means of an interlocking mechanism;

FIG. 8 schematically shows how the interlocking mechanism of the scales helps to transfer introduced forces to be distributed over a wider area;

FIG. 9 schematically shows how the flat cable of the invention is bent at an intersection between a floor and a wall;

FIG. 10a and FIG. 10b schematically show the procedure for removing a scale from the chain of scales;

FIG. 10c schematically shows removal of some of the insulation from the individual conductors;

FIG. 11 schematically shows a wave-like structure of the cable channels underneath the scales; and

FIG. 12 symbolically shows with different embodiments of interlocking features that can be used to interlock adjacent scales.

### DETAILED DESCRIPTION OF EMBODIMENTS OF THE INVENTION

The flat cable system of the present invention can be best understood by explaining the problem for which it is a solution. A standard conference room is taken as a typical example of the abstract problem. Standing in the middle of the conference room is a large table. One or more of: telephones, computers, or other electronic devices, are placed on the conference table. The electrical connections for these devices are at the walls in form of standard outlets. The table is free standing to allow chairs to be placed on all of its sides and with no side close enough to the wall to allow cables to be connected directly from the wall to the devices on its surface. In most cases, to overcome this problem, a small channel large enough to contain the cables is carved into the floor from the wall to a convenient place under the table. After the cables have been installed, the channel in the floor is either closed, for example with cement, or covered over, for example with flooring tiles, so that the surface of the floor remains flat without steps. This type of arrangement can be seen in nearly every large office.

Most floors in offices are made from material that makes the work necessary to create a channel inside the floor beneath the floor-level expensive and time consuming. While it might be possible in many cases to plan this channel under the floor when the office or building is constructed, there are many cases wherein changes of the layout of the conference room occur after the office has been built. In these cases, in addition to the expense involved, the work of creating the channel creates a loud and dusty environment that interferes with the functioning of the office.

The present invention is a flat cable that is sufficiently flat to be fixed on the floor, or laid or glued under a carpet or other thin floor-cover without interfering with the normal movement of people and objects such as carts in the room. Common embodiments of the flat cable of the invention have a height of 0.5 mm to 0.6 mm. This is about twice the thickness of a business card, or four to five sheets of business-paper (stationary) stacked on top of each other. Even when a double sided glue-tape is used to fix this flat cable system to the floor, the height of around 0.5 mm is not significantly increased. Other heights are possible and can be produced depending, amongst other considerations on the type of floor or carpet to which the cable is attached.

The flat cable of the invention is manufactured as a long chain of stable flat plates called herein “scales” that have channels for the electric conductors on their undersides and are connected together in one of the ways described herein below. It can be supplied to the user in standard lengths, e.g. four meters, or as rolls many meters long that can be cut to length according to the requirements of the room in which it is to be installed. The scales themselves can be produced with any desired length and width dimensions, and with any number of channels into which insulated wires are pressed. The most commonly produced embodiment of the flat cable is designed for 8P8C (RJ45) cables comprising eight signal wires or six signal wires and two low voltage DC wires and has scale dimensions of 70 mm×60 mm×0.55 mm (length×width×height). The scales are made from a rigid material such as a noncorrosive metal, e.g. Aluminum 6061 with anodize coating, stainless steel 303, or PEABS plastic material with an inserted metal strip for electrical conductivity.

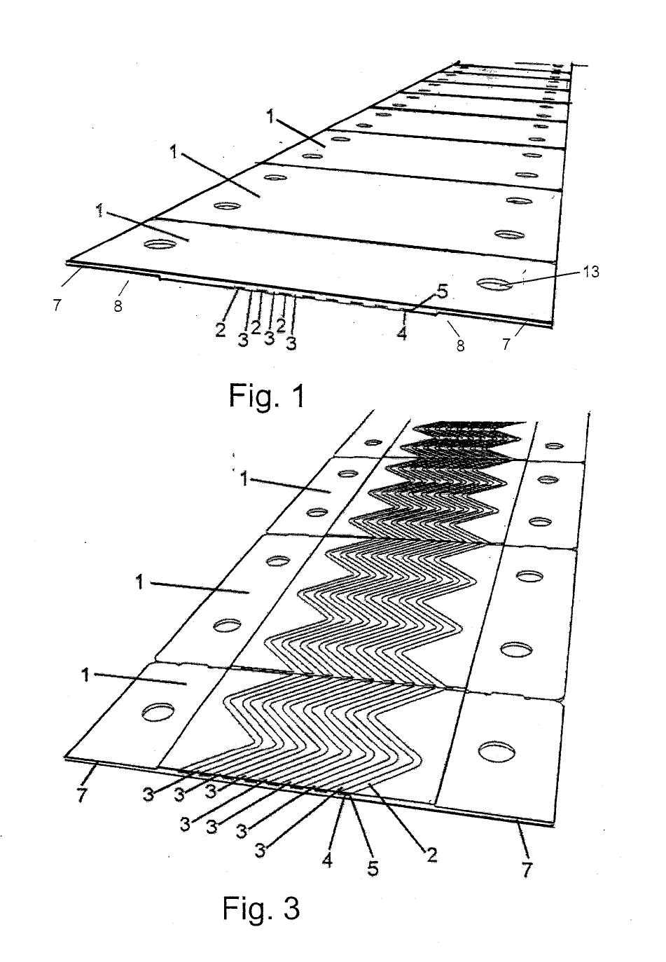

FIG. 1 schematically shows a top view of a portion of an embodiment of the flat cable of the invention comprising a number of scales (1) connected together. The ends of the wire channels (2) are clearly visible on the edge of the end scale, as well as the inner walls (3), which provide support that prevents the scale from being crushed or otherwise damaged if weight, e.g. a person's foot, is placed on top of it. The conductor (4) and the insulation (5) surrounding the conductor are also partly visible in FIG. 1. Embodiments of the scales (1) comprise overhanging edges (7) that create a space (8) that can be used for double-sided glue tape on both sides of the scale. Embodiments of the scales (1) comprise one or more holes (13) that pass vertically through them. In embodiments of the invention holes (13) can have several functions. One of these is that screws, nails, or other fixing elements can pass through them to attach the scale to an object, e.g. floor, wall, or furniture. Other uses of holes (13) will be described herein below.

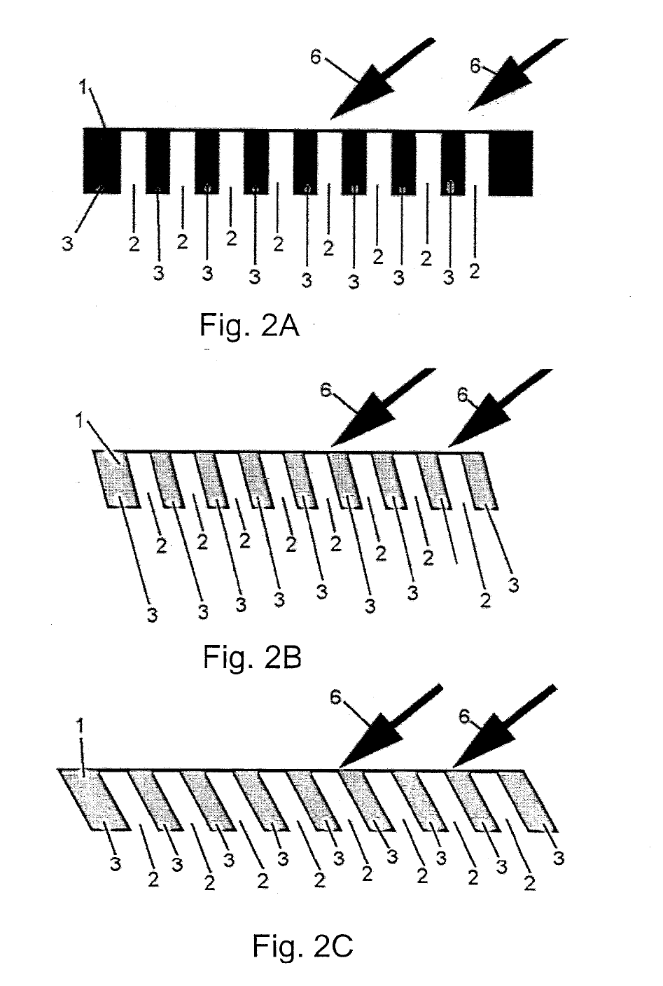

In the usual installation the cable would be laid on the floor along a relative straight line from the wall to the table and thus intersects the path of a person walking to the table at an angle of about ninety degrees. If a person steps on the edge of this very flat cable a large force is exerted on the thin and thus weak structure at an angle of about 90 degrees to the direction the cable is laid. If the wire channels (2) are straight then the resulting side force (6), would bend the scale as shown schematically in FIG. 2a to FIG. 2c and will ultimately destroy it after relative short time.

The present invention overcomes this problem by creating the channels (2) in the bottom of the rigid scales (1) such that they do not run parallel to the side edges of the scales (1) but at angles in a zigzag-pattern. FIG. 3 schematically shows a bottom view of the flat cable of FIG. 1 revealing the zigzag-pattern of the channels (2) for the electrical wires. The zigzag-pattern creates a partial sidewards directed wall that gives stability to the system.

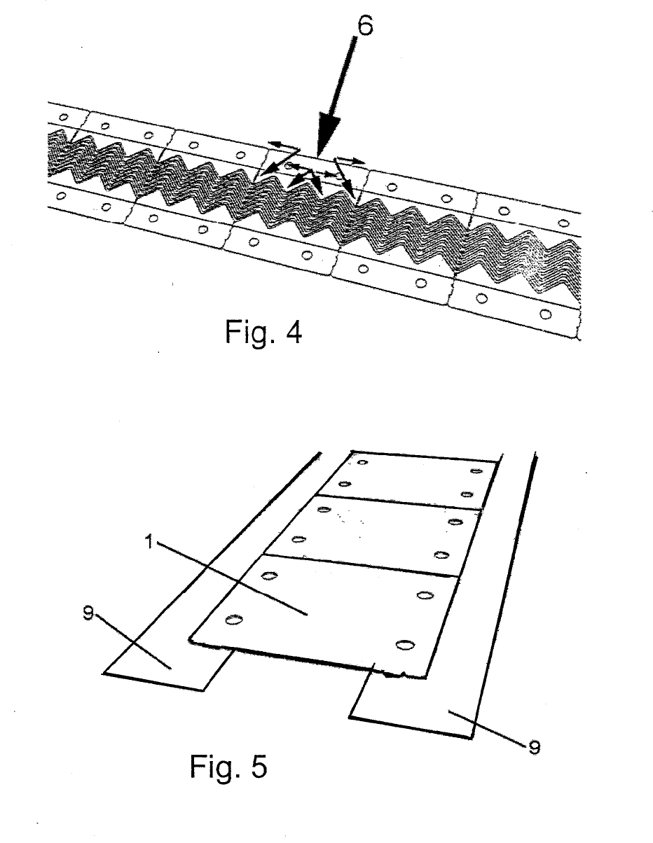

FIG. 4 schematically shows a force (6) exerted perpendicular to the side of a scale of the invention and smaller arrows, representing the force-vectors of components of force (6). FIG. 4 shows how the force is introduced into the interior of the structure along the direction of the sides of the channels (2). What becomes immediately visible and clear is that this structure is able to withstand much higher forces, because the forces are now introduced into the structure in a direction at least partially parallel to the channels and not perpendicular to them. This gives the flat cable structure of the invention the necessary strength to withstand strong forces that are created when for example a person weighing 100 kg or more steps with some momentum onto the edge of the cable structure. By using a design where the main support, i.e. inner walls (3) is not parallel to the direction of the scale large side forces that are introduced into the cable structure are diverted and absorbed and the flat cable will not be destroyed.

The zigzag pattern of the channels (2) creates diagonal sections of inner walls (3) that gives the flat cable extra strength in the vertical direction. The scales are 0.5 to 0.6 mm thick. From this thickness the height of the cable-channels (2) removed so that only a very thin layer of material 0.1 to 0.2 mm thick remains at the top of the scale above the wire channels. If the wire channels were straight then, when weight is applied on the cable when it is laid, glued or otherwise fixed on a floor or under a carpet, the whole cable could easily be bent along these thin sections and the whole cable construction would be highly unstable.

The angle of the diagonal parts of the zigzag-pattern can be chosen by the manufacturer of the cable system of the invention as can be the radius at the corners of the zigzag form of the inner walls. A 45-degrees angle gives the highest stability at the shortest distance and is used in the standard embodiment of the invention and, as an example, is shown in most of the drawings.

There are several ways in which the scales can be connected to each other in the chain-like fashion necessary to form the flat cable of the invention. The basic connection that is inherent in the cable is that the insulated wires fit tightly enough into the wire channels (2) to maintain the mechanical integrity of the cable with the scales butting against one another or with a small gap between adjacent scales.

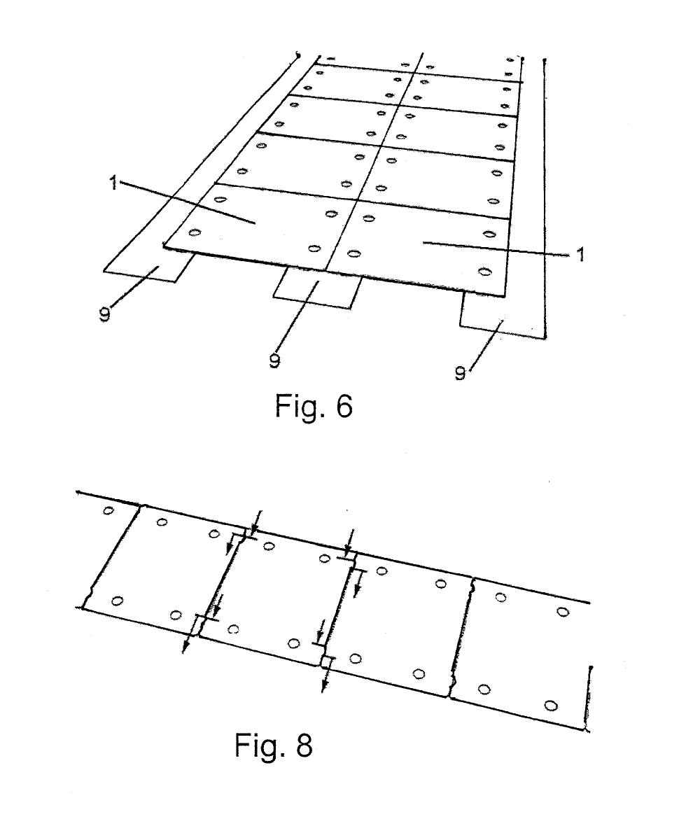

In FIG. 1 is shown the two overhanging edges (7) on the sides of the scales (1) and the spaces (8) underneath them. In embodiments of the invention the height of space (8) is adjusted to exactly accommodate a standard double-sided glue tape (9). In this invention this double-sided glue tape (9) serves two functions. Firstly the bottom of the tape fixes the cable structure to a floor—without increasing the height of the cable. Secondly the top of the tape assists the cable structure to attach adjacent scales to each other and will also attach the cable to a rug or carpet that is laid over it. FIG. 5 schematically shows the flat cable with two double-sided glue tapes (9) attached. Double-sided glue tape can also be used to connect several of the flat cables in parallel to each other as shown schematically in FIG. 6.

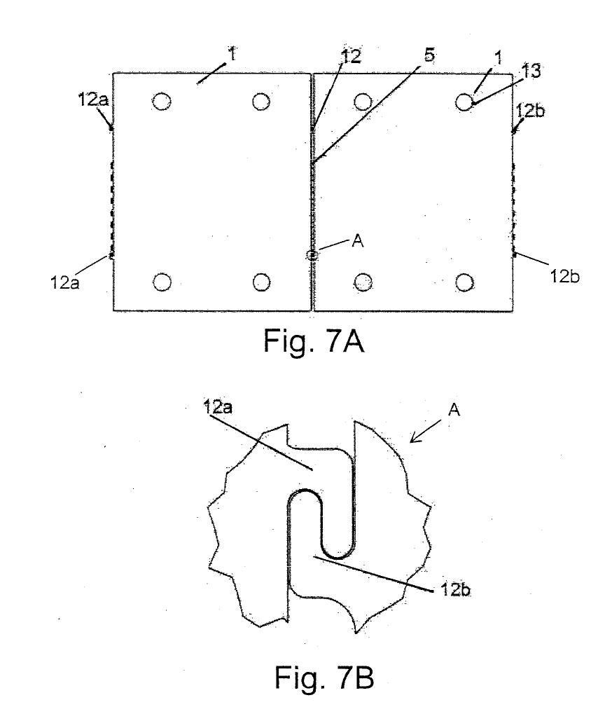

FIG. 7a and FIG. 7b schematically show an embodiment of a way in which adjacent scales (1) can be connected to each other by means of an interlocking mechanism (12). In FIG. 7a it is shown how the scale (1) is manufactured with two U-shaped hooks (12a) projecting from its edge and two matching U-shaped hooks (12b) projecting from its opposite edge. FIG.

7b is an enlarged view of area A in FIG. 7a. In FIG. 7b is seen how the interlocking mechanism (12) is created by engaging hook (12a) on one scale with hook (12b) on the adjacent scale.

In many installations it will be necessary, either because it is a requirement of local wiring regulations or as a design choice to achieve maximum performance, that the flat cable of the invention be grounded. If the scales are made of metal then they act as an electrical shielding and can be grounded. This shielding would not just shield the different conductors (4) passing through wire channels (2) from outside influences, but walls (3) between channels would also shield each single wire from the other wires. The holes (13) on each scale can be used to connect the chain of scales to an external ground wire.

If the chain of scales (1) is held together only by the insulated wires running through wire channels (2), then, for the purposes of the ground, electrical continuity between adjacent scales depends on all scales butting firmly against one another. Since this will not always be the case (see for example the description herein below of how the flat cable is bent at the intersection of a floor with a wall), other means of insuring electrical continuity between adjacent scales is required.

One way of insuring electrical continuity between adjacent scales is to leave a small link of metal between two scales at their seam-line that can function as an electrical bridge (See electrical bridge 14 in FIG. 12) during production.

This link should be thin enough and small enough to allow bending of the cable structure at the seam-line between two scales. Another way of insuring electrical continuity is to attach a continuous conductor, e.g. a wire or strip of metal, to each scale in the chain during the manufacturing process. Another way is to attach small pieces of electrically connecting material to form a bridge between each adjacent pairs of scales. An interlock mechanism such as shown in FIG. 7a and Fig.7b also provides electrical continuity between adjacent scales.

An advantage of the use of the interlocking mechanism (12) is that, when a heavy person steps side wards on the flat cable, the interlocking mechanism helps to transfer the forces on the scale that is stepped on to the neighboring scales. FIG. 8 schematically shows how the force introduced at a specific point is reduced by being distributed to a wider area.

When the cable of the invention is mounted on a floor it has to be bent upwards at the intersection between floor and wall and continue up the wall to the socket. The use of the rigid scales allows the flat cable of the invention to be bent without tools at the seam (14) between scales at the necessary angle, e.g. 90 degrees, to run up the wall.

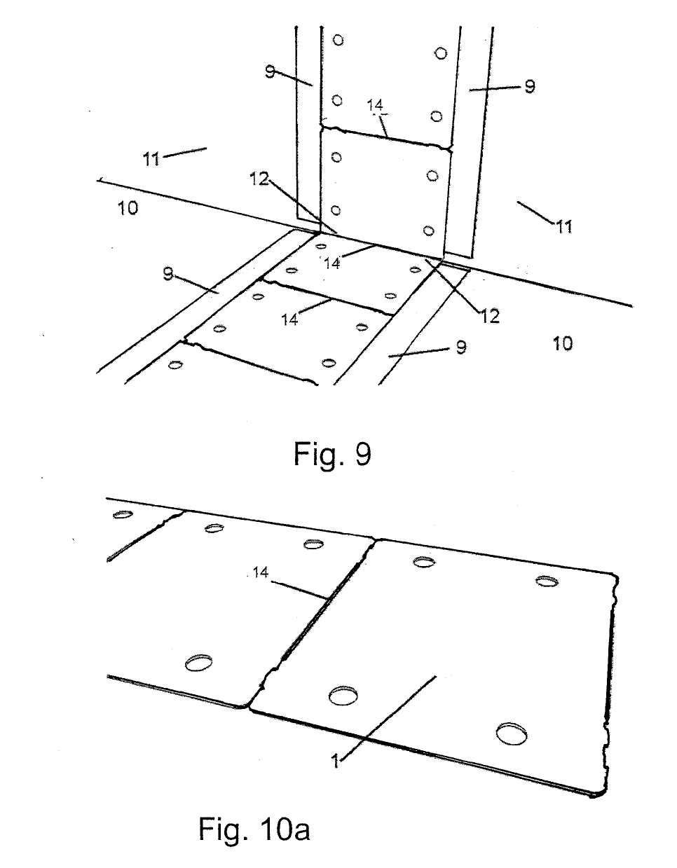

FIG. 9 schematically shows an intersection between floor (10) and wall (11) with the bent cable. The interlocking mechanism (12) provides not only the physical connection between the section of the cable system on the floor and that on the wall but also insures the electrical conductivity of the electrical shielding.

When the cable has to be connected—for example to a crimp-connection inside an outlet-box or to a terminal-block, then the cable is cut at a seam-line (14) between two scales and scales are removed to get unprotected, uncovered conductors that can easily be connected. The seam line (14) between two scales has in the preferred embodiment sufficient space that allows the cables to bend easily and at the same time to use the space between two scales to cut the interlocking mechanism and any other ground connection with a carpet-knife or a similar device or tool in order to separate scales from the rest of the chain. This space between two scales is designed to cover the cables and at the same time to allow adjacent scales touch each other at the exact location of the interlocking mechanism.

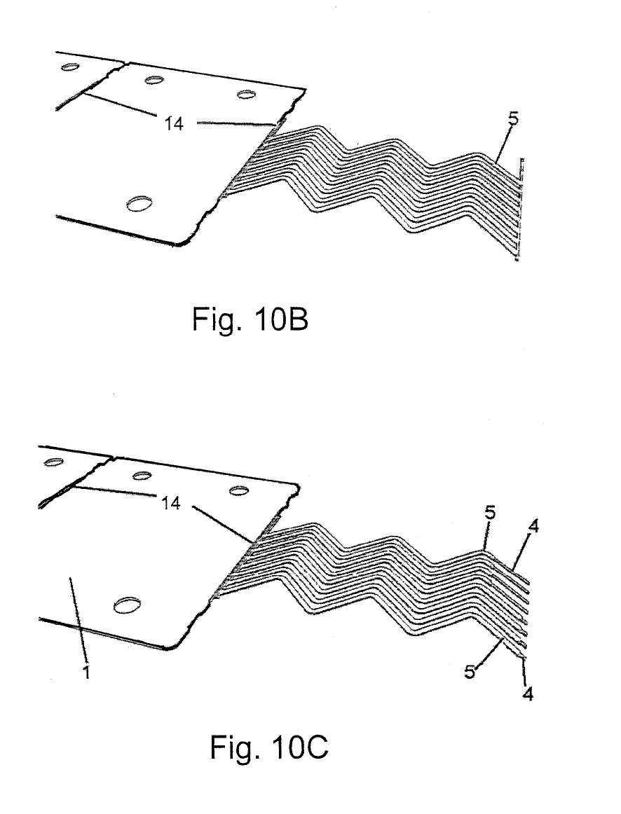

FIG. 10a and FIG. 10b schematically show the procedure described in the previous paragraph for removing a scale (in this example only one scale is removed) and FIG. 10c schematically shows removal of some of the insulation (5) from the single conductors (4).

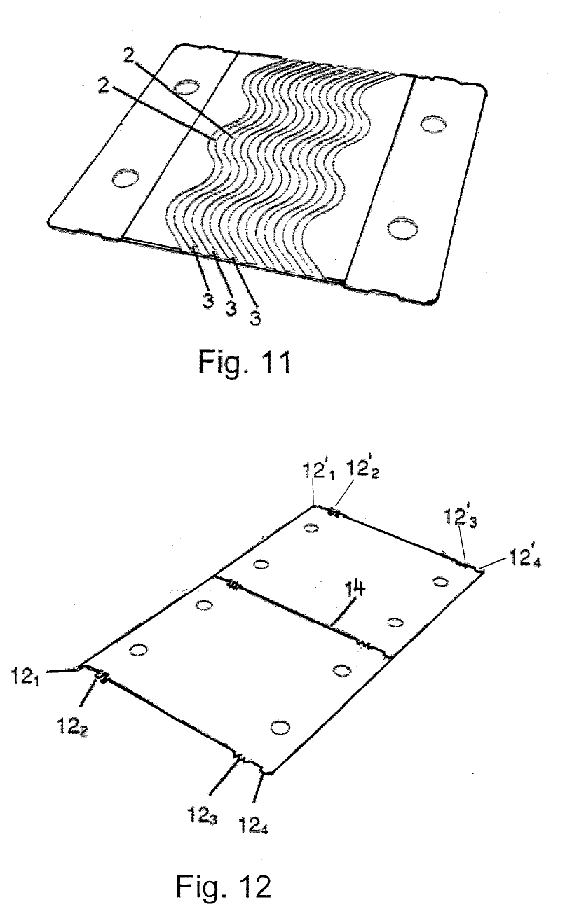

The standard embodiment that has been described above shows clearly the advantages and the improvement to other cables used for similar purposes. It is also possible to change the number of the conductors to a higher or lower number, to change any of the dimensions, whether the height, the width or the length of the scales and the angle of the zigzag pattern. It is also possible to change the radii at the corners of the channels on the bottom of the scales in a way that that zigzag pattern changes into a different pattern that allows the compensation of side forces, for example a wave pattern as it can be seen in FIG. 11.

Also, in addition to the method shown in FIGS. 7a and 7b, there are endless possibilities for accomplishing the interlocking of adjacent scales. FIG. 12 symbolically shows a few different shapes of projections 121 to 124 on one edge of a scale that will fit into mating recesses 12′₁ to 12′₄ on the other edge of the scale. Also shown in FIG. 12 is an electrical bridge 14, which is described herein above.

Although embodiments of the invention have been described by way of illustration, it will be understood that the invention may be carried out with many variations, modifications, and adaptations, without exceeding the scope of the claims.

1. A flat cable comprised of stable flat plates connected together to form a long chain, said plates made from a rigid material and having channels for electric conductors on their undersides; wherein, said channels are created as recesses in the bottom of said plates such that they do not run parallel to the side edges of said long chain of plates but at angles to the side edge in a zigzag or wave-like pattern.

2. The flat cable of claim 1, wherein the height of the plates is between 0.5 mm to 0.6 mm.

3. The flat cable of claim 1, comprising eight channels for eight signal wires or six signal wires and two low voltage DC wires.

4. The flat cable of claim 1, wherein the plates have dimensions of 70 mm×60 mm×0.55 mm (length×width×height).

5. The flat cable of claim 1, wherein at least one of the sides that form one of the two edges parallel to a longitudinal axis of the chain of plates comprises an overhanging edge that creates a space beneath it.

6. The flat cable of claim 5, wherein double-sided glue tape is inserted into the spaces in order to do at least one of the following: to fix the flat cable to a floor; to attach the cable to a rug or carpet that is laid over it by means of a part of the double-sides glue tape that is not covered by said overhanging edge; to connect flat cables in parallel to each other by fixing two adjacent flat cables on the same glue tape.

7. The flat cable of claim 1, wherein at least some of the plates comprise at least one hole that passes vertically through them.

8. The flat cable of claim 7, wherein the holes are used to allow fixing elements to attach the plate to an object.

9. The flat cable of claim 1, wherein the plates are connected together by the insulated wires, which fit tightly into the wire channels; thereby maintaining adjacent plates butted up against one another or with a small gap between them.

10. The flat cable of claim 1, wherein adjacent plates are connected to each other by means of an interlocking mechanism.

11. The flat cable of claim 10, wherein the interlocking mechanism comprises at least one of: interlocking pairs of U-shaped hooks; projections on one edge of a plate that fit into mating recesses on the edge of an adjacent plate; an electrical bridge.

12. The flat cable of claim 1, wherein said cable is electrically grounded.

13. The flat cable of claim 12, wherein electrical grounding is accomplished in at least one of the following ways: using a conducting material to manufacture the plates and butting them firmly against one another; during production leaving at least one small link of metal between two scales at their seam-line that can function as an electrical bridge; attaching a continuous conductor to each plate in the chain during the manufacturing process; to use an interlock mechanism to provide electrical continuity between adjacent plates.
